(19) United States
(12) Patent Application Publication
(10) Pub. No.: US 2026/0187130 A1
(43) Pub. Date: Jul. 2, 2026

(54) SYSTEMS AND METHODS FOR KNOWLEDGE ARTICLE PREDICTION AND ANSWER GENERATION FROM HISTORICAL SERVICE TICKETS

(71) Applicant: Automation Anywhere, Inc., San Jose, CA (US)

(72) Inventors: Antonio NUCCI, San Jose, CA (US); Muddu SUDHAKAR, Saratoga, CA (US); Christos TRYFONAS, Foster City, CA (US); Purushottam AMRADKAR, Sammamish, WA (US)

(21) Appl. No.: 19/011,904

(22) Filed: Jan. 7, 2025

Related U.S. Application Data
(60) Provisional application No. 63/619,091, filed on Jan. 9, 2024.

(51) Int. Cl. G06F 16/34; G06F 40/295

(52) U.S. Cl. CPC G06F 16/345; G06F 40/295

(57) ABSTRACT

Described herein are methods, systems, and media for knowledge article prediction from historical or open service tickets comprising service ticket summarization and intent extraction and knowledge article prediction in off-line or real-time pipelines.

### CROSS-REFERENCE

This application claims the benefit of U.S. Provisional Application No. 63/619,091, filed Jan. 9, 2024, which is hereby incorporated by reference in its entirety herein for all purposes.

### BACKGROUND

Generative artificial intelligence (AI) is artificial intelligence capable of generating text, images, or other media, using generative models. Advances in transformer-based deep neural networks have enabled a number of generative AI systems notable for accepting natural language prompts as input. One such type of model, a large language model (LLM), is a deep learning algorithm that can recognize, summarize, translate, predict and generate text and other forms of content based on knowledge gained from massive datasets. LLMs cans improve enterprise operations, making them more efficient, accurate, and personalized.

### SUMMARY

In one aspect disclosed herein are computer-implemented methods for knowledge article prediction from historical service tickets comprising: providing an off-line training pipeline configured to perform operations including: receiving a plurality of historical service tickets, applying a ticket summarization and intent extraction model to extract one or more historical service ticket enriched intents from each of the plurality of historical service tickets, training an intent to knowledge prediction model to predict one or more historical knowledge articles from each of the one or more historical service ticket enriched intents; and providing a real-time prediction pipeline configured to perform operations including: receiving an open service ticket, applying the ticket summarization and intent extraction model to extract one or more open service ticket enriched intents from the open service ticket, applying the intent to knowledge prediction model to predict one or more knowledge articles from each of the one or more open service ticket enriched intents, and providing the one or more knowledge articles. In some embodiments, the method further comprises applying an answer generation model to generate an answer resolving the open service ticket from the one or more knowledge articles and the one or more open service ticket enriched intents. In some embodiments, the answer generation model comprises one or more LLMs. In further embodiments, the one or more LLMs are trained on a library of historical service tickets. In various further embodiments, the library includes, for example, at least 100, at least 200, at least 300, at least 400, at least 500, at least 600, at least 700, at least 800, at least 900, at least 1,000, at least 2,000, at least 3,000, at least 4,000, at least 5,000, at least 6,000, at least 7,000, at least 8,000, at least 9,000, at least 10,000, at least 20,000, at least 30,000, at least 40,000, at least 50,000, at least 60,000, at least 70,000, at least 80,000, at least 90,000, at least 100,000, at least 200,000, at least 300,000, at least 400,000, at least 500,000, at least 600,000, at least 700,000, at least 800,000, at least 900,000, at least 1,000,000, or more historical service tickets, including increments therein. In some additional embodiments, one or more of the historical service tickets are associated with at least one, at least two, at least three, at least four, at least five, at least six, at least seven, at least eight, at least nine, at least ten, at least twenty, at least thirty, at least forty, at least fifty, at least sixty, at least seventy, at least eighty, at least ninety, at least one hundred, or more of the one or more historical knowledge articles. In further embodiments, the answer comprises at least a portion of at least one of the one or more knowledge articles. In further embodiments, the answer comprises the one or more knowledge articles. In further embodiments, the method further comprises providing the answer to one or more of a service agent, an LLM, or a user device. In some embodiments the ticket summarization and intent extraction model comprises one or more LLMs. In some embodiments the ticket summarization and intent extraction model comprises a summarization module and an extraction module. In further embodiments, the summarization module generates a service ticket summary and the extraction module extracts one or more enriched intents from the service ticket summary. In some embodiments the ticket summarization and intent extraction model is configured to receive instructions for how to process a service ticket. In further embodiments, the instructions comprise operations including entity extraction, entity enrichment, or output formatting. In some embodiments the ticket summarization and intent extraction model is configured to perform operations including: extracting one or more intents from a service ticket, extracting one or more system messages from the service ticket, enriching the one or more intents with the one or more system messages, and providing the one or more enriched intents. In some embodiments one or both of the one or more historical service ticket enriched intents or the one or more open service ticket enriched intents are at least a portion of a JSON-formatted output of the ticket summarization and intent extraction model. In some embodiments the intent to knowledge prediction model comprises an LLM. In further embodiments, the LLM is trained on a library of historical service tickets associated with knowledge articles. In yet further embodiments, the library includes, for example, at least 100, at least 200, at least 300, at least 400, at least 500, at least 600, at least 700, at least 800, at least 900, at least 1,000, at least 2,000, at least 3,000, at least 4,000, at least 5,000, at least 6,000, at least 7,000, at least 8,000, at least 9,000, at least 10,000, at least 20,000, at least 30,000, at least 40,000, at least 50,000, at least 60,000, at least 70,000, at least 80,000, at least 90,000, at least 100,000, at least 200,000, at least 300,000, at least 400,000, at least 500,000, at least 600,000, at least 700,000, at least 800,000, at least 900,000, at least 1,000,000, or more historical service tickets associated with historical knowledge articles, including increments therein. In some additional embodiments, each of the historical service tickets are associated with at least one, at least two, at least three, at least four, at least five, at least six, at least seven, at least eight, at least nine, at least ten, at least twenty, at least thirty, at least forty, at least fifty, at least sixty, at least seventy, at least eighty, at least ninety, at least one hundred, or more of the one or more historical knowledge articles. In some embodiments each of the one or more historical service ticket enriched intents comprises an intent and a plurality of system messages. In some embodiments of the one or more open service ticket enriched intents comprises an intent and a plurality of system messages. In some additional embodiments, the plurality of system messages comprises one or more of error messages, status codes, warning messages, system warnings, or references to products. In some embodiments each of the plurality of historical service tickets comprises a ticket ID, a ticket description, or a ticket title. In some embodiments the open service ticket comprises a ticket ID, a ticket description, or a ticket title. In some embodiments one or more of the plurality of historical service tickets or the open service ticket are received from a user device.

In another aspect disclosed herein are computer-implemented methods for knowledge article prediction from an open service ticket comprising: receiving the open service ticket; applying a ticket summarization and intent extraction model to extract one or more open service ticket enriched intents from the open service ticket; applying an intent to knowledge prediction model to predict one or more knowledge articles from each of the one or more open service ticket enriched intents; and providing the one or more knowledge articles.

In yet another aspect disclosed herein are computer-implemented systems comprising at least one processor and instructions causing the at least one processor to perform operations comprising: providing an off-line training pipeline configured to perform operations including: receiving a plurality of historical service tickets, applying a ticket summarization and intent extraction model to extract one or more historical service ticket enriched intents from each of the plurality of historical service tickets, training an intent to knowledge prediction model to predict one or more historical knowledge articles from each of the one or more historical service ticket enriched intents; and providing a real-time prediction pipeline configured to perform operations including: receiving an open service ticket, applying the ticket summarization and intent extraction model to extract one or more open service ticket enriched intents from the open service ticket, applying the intent to knowledge prediction model to predict one or more knowledge articles from each of the one or more open service ticket enriched intents, and providing the one or more knowledge articles. In some embodiments, the operations further comprise applying an answer generation model to generate an answer resolving the open service ticket from the one or more knowledge articles and the one or more open service ticket enriched intents. In further embodiments, the answer generation model comprises one or more LLMs. In yet further embodiments the one or more LLMs are trained on a library of historical service tickets. In still further embodiments, the library includes, for example, at least 100, at least 200, at least 300, at least 400, at least 500, at least 600, at least 700, at least 800, at least 900, at least 1,000, at least 2,000, at least 3,000, at least 4,000, at least 5,000, at least 6,000, at least 7,000, at least 8,000, at least 9,000, at least 10,000, at least 20,000, at least 30,000, at least 40,000, at least 50,000, at least 60,000, at least 70,000, at least 80,000, at least 90,000, at least 100,000, at least 200,000, at least 300,000, at least 400,000, at least 500,000, at least 600,000, at least 700,000, at least 800,000, at least 900,000, at least 1,000,000, or more historical service tickets, including increments therein. In some additional embodiments, one or more of the historical service tickets are associated with at least one, at least two, at least three, at least four, at least five, at least six, at least seven, at least eight, at least nine, at least ten, at least twenty, at least thirty, at least forty, at least fifty, at least sixty, at least seventy, at least eighty, at least ninety, at least one hundred, or more of the one or more historical knowledge articles. In further embodiments, the answer comprises at least a portion of at least one of the one or more knowledge articles. In further embodiments, the answer comprises the one or more knowledge articles. In further embodiments, the operations further comprise providing the answer to one or more of a service agent, an LLM, or a user device. In some embodiments the ticket summarization and intent extraction model comprises one or more LLMs. In some embodiments the ticket summarization and intent extraction model comprises a summarization module and an extraction module. In further embodiments, the summarization module generates a service ticket summary and the extraction module extracts one or more enriched intents from the service ticket summary. In some embodiments the ticket summarization and intent extraction model is configured to receive instructions for how to process a service ticket. In further embodiments, the instructions comprise operations including entity extraction, entity enrichment, or output formatting. In some embodiments the ticket summarization and intent extraction model is configured to perform operations including: extracting one or more intents from a service ticket, extracting one or more system messages from the service ticket, enriching the one or more intents with the one or more system messages, and providing the one or more enriched intents. In some embodiments one or both of the one or more historical service ticket enriched intents or the one or more open service ticket enriched intents are at least a portion of a JSON-formatted output of the ticket summarization and intent extraction model. In some embodiments the intent to knowledge prediction model comprises an LLM. In further embodiments, the LLM is trained on a library of historical service tickets associated with knowledge articles. In yet further embodiments, the library includes, for example, at least 100, at least 200, at least 300, at least 400, at least 500, at least 600, at least 700, at least 800, at least 900, at least 1,000, at least 2,000, at least 3,000, at least 4,000, at least 5,000, at least 6,000, at least 7,000, at least 8,000, at least 9,000, at least 10,000, at least 20,000, at least 30,000, at least 40,000, at least 50,000, at least 60,000, at least 70,000, at least 80,000, at least 90,000, at least 100,000, at least 200,000, at least 300,000, at least 400,000, at least 500,000, at least 600,000, at least 700,000, at least 800,000, at least 900,000, at least 1,000,000, or more historical service tickets associated with historical knowledge articles, including increments therein. In some additional embodiments, each of the historical service tickets are associated with at least one, at least two, at least three, at least four, at least five, at least six, at least seven, at least eight, at least nine, at least ten, at least twenty, at least thirty, at least forty, at least fifty, at least sixty, at least seventy, at least eighty, at least ninety, at least one hundred, or more of the one or more historical knowledge articles. In some embodiments each of the one or more historical service ticket enriched intents comprises an intent and a plurality of system messages. In some embodiments each of the one or more open service ticket enriched intents comprises an intent and a plurality of system messages. In some additional embodiments, the plurality of system messages comprises one or more of error messages, status codes, warning messages, system warnings, or references to products. In some embodiments each of the plurality of historical service tickets comprises a ticket ID, a ticket description, or a ticket title. In some embodiments the open service ticket comprises a ticket ID, a ticket description, or a ticket title. In some embodiments, one or more of the plurality of historical service tickets or the open service ticket are received from a user device. In some embodiments one or both of the plurality of historical service tickets and the plurality of open service tickets are received from a user device. In some embodiments, the one or more open service ticket enriched intents and the one or more knowledge articles are provided to a third-party LLM. In further embodiments, the third-party LLM is a chatbot. In yet further embodiments, the third-party LLM provides a resolution to the open service ticket. In still further embodiments, the resolution comprises at least a portion of at least one of the knowledge articles. In still further embodiments, the resolution is provided to a user. In even further embodiments, the user is a service agent. In some embodiments the system is disposed between a customer relationship management system and a third-party LLM.

In still another aspect disclosed herein are one or more non-transitory computer-readable storage media encoded with instructions executable by one or more processors to provide an application comprising: a software module providing an off-line training pipeline configured to perform operations including: receiving a plurality of historical service tickets, applying a ticket summarization and intent extraction model to extract one or more historical service ticket enriched intents from each of the plurality of historical service tickets, training an intent to knowledge prediction model to predict one or more historical knowledge articles from each of the one or more historical service ticket enriched intents; and a software module providing a real-time prediction pipeline configured to perform operations including: receiving an open service ticket, applying the ticket summarization and intent extraction model to extract one or more open service ticket enriched intents from the open service ticket, applying the intent to knowledge prediction model to predict one or more knowledge articles from each of the one or more open service ticket enriched intents, and providing the one or more knowledge articles.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 shows a non-limiting example of a computing device; in this case, a device with one or more processors, memory, storage, and a network interface, per one or more embodiments herein;

FIG. 2 shows a first diagram of an exemplary technology stack, per one or more embodiments herein;

FIG. 3 shows a second diagram of an exemplary technology stack; in this case, a technology stack with large language model (LLM) emphasis;

FIG. 4 shows a diagram of an exemplary method of prompt registration configured at an admin console through an LLM gateway, per one or more embodiments herein;

FIG. 5 shows a non-limiting example of a graphic user interface (GUI); in this case, a GUI for an admin console showing artificial intelligence (AI) service desk features;

FIG. 6 shows a non-limiting example of a GUI; in this case, a GUI for an admin console showing AI ops desk features;

FIG. 7 shows a non-limiting example of a GUI; in this case, a GUI for an admin console showing AI support intelligence features;

FIG. 8 shows a non-limiting example of a logical architecture of a knowledge prediction system; in this case, with both an off-line training pipeline and a real-time prediction pipeline; and

FIG. 9 shows a non-limiting example of an answer generation system; in this case; an answer generation system to take ticket intents and knowledge articles as input to generate an answer.

### DETAILED DESCRIPTION

Described herein, in certain embodiments, are computer-implemented methods for knowledge article prediction from historical service tickets comprising: providing an off-line training pipeline configured to perform operations including: receiving a plurality of historical service tickets, applying a ticket summarization and intent extraction model to extract one or more historical service ticket enriched intents from each of the plurality of historical service tickets, training an intent to knowledge prediction model to predict one or more historical knowledge articles from each of the one or more historical service ticket enriched intents; and providing a real-time prediction pipeline configured to perform operations including: receiving an open service ticket, applying the ticket summarization and intent extraction model to extract one or more open service ticket enriched intents from the open service ticket, applying the intent to knowledge prediction model to predict one or more knowledge articles from each of the one or more open service ticket enriched intents, and providing the one or more knowledge articles.

Also described herein, in certain embodiments, are computer-implemented methods for knowledge article prediction from an open service ticket comprising: receiving the open service ticket; applying a ticket summarization and intent extraction model to extract one or more open service ticket enriched intents from the open service ticket; applying an intent to knowledge prediction model to predict one or more knowledge articles from each of the one or more open service ticket enriched intents; and providing the one or more knowledge articles.

Also described herein, in certain embodiments, are computer-implemented systems comprising at least one processor and instructions causing the at least one processor to perform operations comprising: providing an off-line training pipeline configured to perform operations including: receiving a plurality of historical service tickets, applying a ticket summarization and intent extraction model to extract one or more historical service ticket enriched intents from each of the plurality of historical service tickets, training an intent to knowledge prediction model to predict one or more historical knowledge articles from each of the one or more historical service ticket enriched intents; and providing a real-time prediction pipeline configured to perform operations including: receiving an open service ticket, applying the ticket summarization and intent extraction model to extract one or more open service ticket enriched intents from the open service ticket, applying the intent to knowledge prediction model to predict one or more knowledge articles from each of the one or more open service ticket enriched intents, and providing the one or more knowledge articles.

Also described herein, in certain embodiments, are one or more non-transitory computer-readable storage media encoded with instructions executable by one or more processors to provide an application comprising: a software module providing an off-line training pipeline configured to perform operations including: receiving a plurality of historical service tickets, applying a ticket summarization and intent extraction model to extract one or more historical service ticket enriched intents from each of the plurality of historical service tickets, training an intent to knowledge prediction model to predict one or more historical knowledge articles from each of the one or more historical service ticket enriched intents; and a software module providing a real-time prediction pipeline configured to perform operations including: receiving an open service ticket, applying the ticket summarization and intent extraction model to extract one or more open service ticket enriched intents from the open service ticket, applying the intent to knowledge prediction model to predict one or more knowledge articles from each of the one or more open service ticket enriched intents, and providing the one or more knowledge articles.

### Terms and Definitions

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise. Any reference to “or” herein is intended to encompass “and/or” unless otherwise stated.

As used herein, the term “about” in some cases refers to an amount that is approximately the stated amount, in some cases near the stated amount by 10%, 5%, or 1%, including increments therein, and in some cases, in reference to a percentage, refers to an amount that is greater or less the stated percentage by 10%, 5%, or 1%, including increments therein.

As used herein, the phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C”, “one or more of A, B, or C” and “A, B, and/or C” means A alone, B alone, C alone, A and B together, A and C together, B and C together, or A, B and C together.

Service Ticket: As used herein, “service ticket” in some cases refers to a communication from a user describing one or more technical issues or questions experienced by the user with the purpose of obtaining a resolution to the one or more technical issues or questions.

Knowledge Article: As used herein, “knowledge article” in some cases refers to a physical or virtual document containing information pertinent to an issue, question, or information request experienced by a user.

Reference throughout this specification to “some embodiments,” “further embodiments,” or “a particular embodiment,” means that a particular feature, structure, or characteristic described in connection with the embodiment is included in at least one embodiment. Thus, the appearances of the phrase “in some embodiments,” or “in further embodiments,” or “in a particular embodiment” in various places throughout this specification are not necessarily all referring to the same embodiment. Furthermore, the particular features, structures, or characteristics may be combined in any suitable manner in one or more embodiments.

### Computing Systems

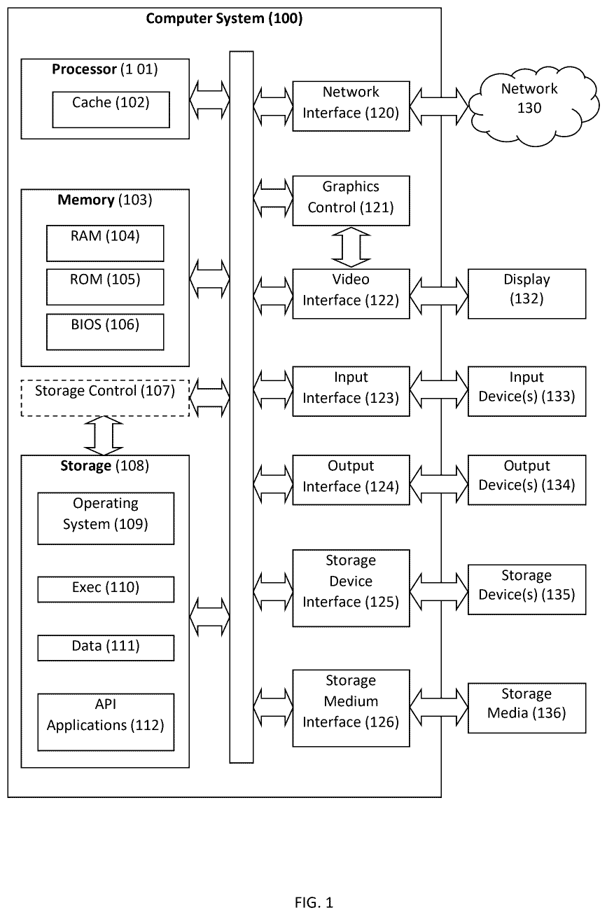

Referring to FIG. 1, a block diagram is shown depicting an exemplary machine that includes a computer system 100 (e.g., a processing or computing system) within which a set of instructions can execute for causing a device to perform or execute any one or more of the aspects and/or methodologies for static code scheduling of the present disclosure. The components in FIG. 1 are examples only and do not limit the scope of use or functionality of any hardware, software, embedded logic component, or a combination of two or more such components implementing particular embodiments.

Computer system 100 may include one or more processors 101, a memory 103, and a storage 108 that communicate with each other, and with other components, via a bus 140. The bus 140 may also link a display 132, one or more input devices 133 (which may, for example, include a keypad, a keyboard, a mouse, a stylus, etc.), one or more output devices 134, one or more storage devices 135, and various tangible storage media 136. All of these elements may interface directly or via one or more interfaces or adaptors to the bus 140. For instance, the various tangible storage media 136 can interface with the bus 140 via storage medium interface 126. Computer system 100 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 100 includes one or more processor(s) 101 (e.g., central processing units (CPUs) or general-purpose graphics processing units (GPGPUs)) that carry out functions. Processor(s) 101 optionally contains a cache memory unit 102 for temporary local storage of instructions, data, or computer addresses. Processor(s) 101 are configured to assist in execution of computer readable instructions. Computer system 100 may provide functionality for the components depicted in FIG. 1 as a result of the processor(s) 101 executing non-transitory, processor-executable instructions embodied in one or more tangible computer-readable storage media, such as memory 103, storage 108, storage devices 135, and/or storage medium 136. The computer-readable media may store software that implements particular embodiments, and processor(s) 101 may execute the software. Memory 103 may read the software from one or more other computer-readable media (such as mass storage device(s) 135, 136) or from one or more other sources through a suitable interface, such as network interface 120. The software may cause processor(s) 101 to carry out one or more processes or one or more steps of one or more processes described or illustrated herein. Carrying out such processes or steps may include defining data structures stored in memory 103 and modifying the data structures as directed by the software.

The memory 103 may include various components (e.g., machine readable media) including, but not limited to, a random access memory component (e.g., RAM 104) (e.g., static RAM (SRAM), dynamic RAM (DRAM), ferroelectric random access memory (FRAM), phase-change random access memory (PRAM), etc.), a read-only memory component (e.g., ROM 105), and any combinations thereof. ROM 105 may act to communicate data and instructions unidirectionally to processor(s) 101, and RAM 104 may act to communicate data and instructions bidirectionally with processor(s) 101. ROM 105 and RAM 104 may include any suitable tangible computer-readable media described below. In one example, a basic input/output system 106 (BIOS), including basic routines that help to transfer information between elements within computer system 100, such as during start-up, may be stored in the memory 103.

Fixed storage 108 is connected bidirectionally to processor(s) 101, optionally through storage control unit 107. Fixed storage 108 provides additional data storage capacity and may also include any suitable tangible computer-readable media described herein. Storage 108 may be used to store operating system 109, executable(s) 110, data 111, applications 112 (application programs), and the like. Storage 108 can also include an optical disk drive, a solid-state memory device (e.g., flash-based systems), or a combination of any of the above. Information in storage 108 may, in appropriate cases, be incorporated as virtual memory in memory 103.

In one example, storage device(s) 135 may be removably interfaced with computer system 100 (e.g., via an external port connector (not shown)) via a storage device interface 125. Particularly, storage device(s) 135 and an associated machine-readable medium may provide non-volatile and/or volatile storage of machine-readable instructions, data structures, program modules, and/or other data for the computer system 100. In one example, software may reside, completely or partially, within a machine-readable medium on storage device(s) 135. In another example, software may reside, completely or partially, within processor(s) 101.

Bus 140 connects a wide variety of subsystems. Herein, reference to a bus may encompass one or more digital signal lines serving a common function, where appropriate. Bus 140 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 100 may also include an input device 133. In one example, a user of computer system 100 may enter commands and/or other information into computer system 100 via input device(s) 133. Examples of an input device(s) 133 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect, Leap Motion, or the like. Input device(s) 133 may be interfaced to bus 140 via any of a variety of input interfaces 123 (e.g., input interface 123) including, but not limited to, serial, parallel, game port, USB, FIREWIRE, THUNDERBOLT, or any combination of the above.

In particular embodiments, when computer system 100 is connected to network 130, computer system 100 may communicate with other devices, specifically mobile devices and enterprise systems, distributed computing systems, cloud storage systems, cloud computing systems, and the like, connected to network 130. Communications to and from computer system 100 may be sent through network interface 120. For example, network interface 120 may receive incoming communications (such as requests or responses from other devices) in the form of one or more packets (such as Internet Protocol (IP) packets) from network 130, and computer system 100 may store the incoming communications in memory 103 for processing. Computer system 100 may similarly store outgoing communications (such as requests or responses to other devices) in the form of one or more packets in memory 103 and communicated to network 130 from network interface 120. Processor(s) 101 may access these communication packets stored in memory 103 for processing.

Examples of the network interface 120 include, but are not limited to, a network interface card, a modem, and any combination thereof. Examples of a network 130 or network segment 130 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 130, may employ a wired and/or a wireless mode of communication. In general, any network topology may be used.

Information and data can be displayed through a display 132. Examples of a display 132 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 132 can interface to the processor(s) 101, memory 103, and fixed storage 108, as well as other devices, such as input device(s) 133, via the bus 140. The display 132 is linked to the bus 140 via a video interface 122, and transport of data between the display 132 and the bus 140 can be controlled via the graphics control 121. In some embodiments, the display is a video projector. In some embodiments, the display is a head-mounted display (HMD) such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In addition to a display 132, computer system 100 may include one or more other peripheral output devices 134 including, but not limited to, an audio speaker, a printer, a storage device, and any combinations thereof. Such peripheral output devices may be connected to the bus 140 via an output interface 124. Examples of an output interface 124 include, but are not limited to, a serial port, a parallel connection, a USB port, a FIREWIRE port, a THUNDERBOLT port, and any combinations thereof.

In addition, or as an alternative, computer system 100 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, cloud computing platforms, distributed computing platforms, server clusters, server computers, desktop computers, laptop computers, notebook computers, sub-notebook computers, netbook computers, and netpad computers.

In some embodiments, the computing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smartphone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®

### Non-Transitory Computer Readable Storage Medium

In some embodiments, the platforms, systems, media, and methods disclosed herein include one or more non-transitory computer readable storage media encoded with a program including instructions executable by the operating system of an optionally networked computing device. In further embodiments, a computer readable storage medium is a tangible component of a computing device. In still further embodiments, a computer readable storage medium is optionally removable from a computing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

### Computer Programs

In some embodiments, the platforms, systems, media, and methods disclosed herein include at least one computer program, or use of the same. A computer program includes a sequence of instructions, executable by one or more processor(s) of the computing device's CPU, written to perform a specified task. Computer readable instructions may be implemented as program modules, such as functions, objects, Application Programming Interfaces (APIs), computing data structures, and the like, which perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, a distributed computing resource, a cloud computing resource, or combinations thereof. In further various embodiments, a software module comprises a plurality of files, a plurality of sections of code, a plurality of programming objects, a plurality of programming structures, a plurality of distributed computing resources, a plurality of cloud computing resources, or combinations thereof. In various embodiments, the one or more software modules comprise, by way of non-limiting examples, a web application, a mobile application, a standalone application, and a distributed or cloud computing application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of, for example, user request, intent, enriched intent, embedding, response, historical knowledge articles, historical service tickets, open service tickets, and model information. In various embodiments, suitable databases include, by way of non-limiting examples, relational databases, non-relational databases, object-oriented databases, object databases, entity-relationship model databases, associative databases, XML databases, document-oriented databases, and graph databases. Further non-limiting examples include SQL, PostgreSQL, MySQL, Oracle, DB2, Sybase, and MongoDB. In some embodiments, a database is Internet-based. In further embodiments, a database is web-based. In still further embodiments, a database is cloud computing based. In a particular embodiment, a database is a distributed database. In other embodiments, a database is based on one or more local computer storage devices.

### LLM Technology Stack

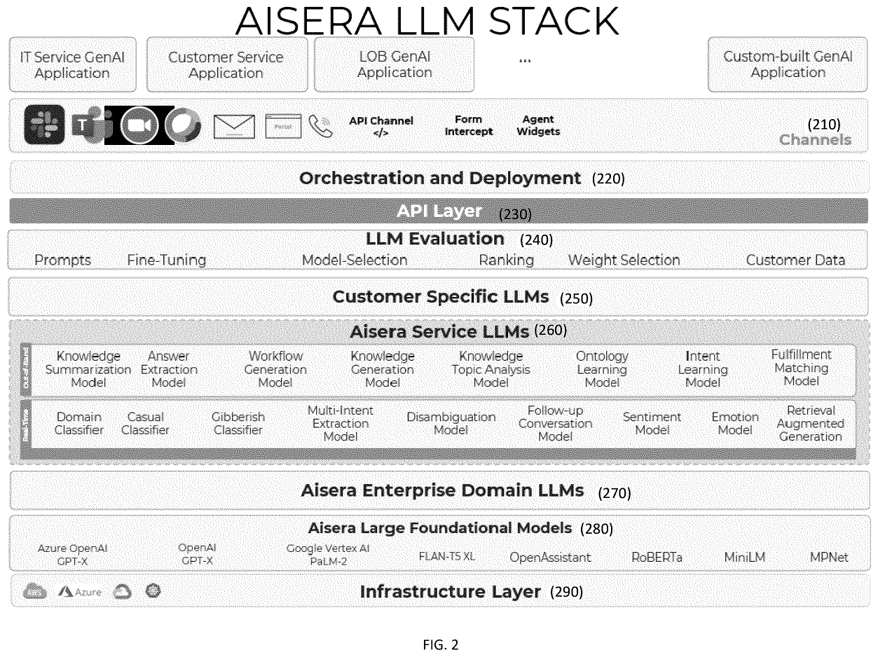

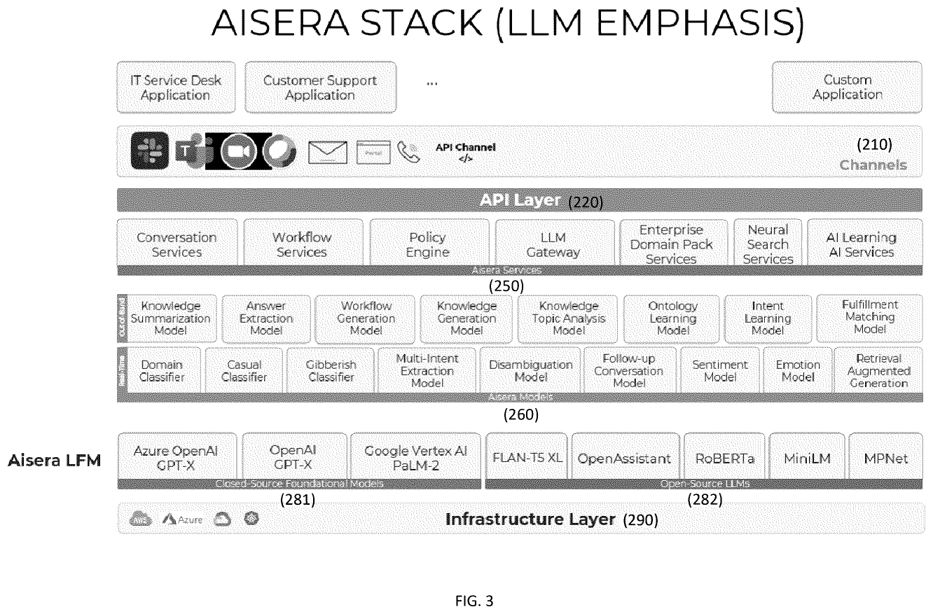

FIGS. 2 and 3 show diagrams of an exemplary Large Language Model (LLM) Technology Stack. In some embodiments, the LLM stack herein can be deployed, scaled and operated both in public clouds (AWS, GCP, Azure, etc.) on an Infrastructure Layer 290 and locally (on-premises) using the Kubernetes container orchestration platform.

In some embodiments, the LLM stack herein embeds a plurality of large foundational models (LFMs) 280, including both closed-source LFMs 281 via an API layer 230 integrated with LFMs, and open-source LFMs 282 via the LFM deployment and execution in secure Kubernetes containers. Non-limiting examples of closed-source LFM providers which are integrated with The LLM stack herein via APIs are Azure OpenAI (complete and chat APIs for GPT-3, GPT-3.5, and GPT-4), OpenAI (complete and chat APIs for GPT-3, GPT-3.5 and GPT-4), Google Vertex AI (PaLM-2). Non-limiting examples of open-source LFM are FLAN-T5, OpenAssistant, ROBERTa, MiniLM, and MPNet.

In some embodiments, the LLM stack herein enables a developer to choose from a pool of supported LFM/LLM models using a catalog, or to integrate a new LFM/LLM model using the LLM Gateway. In some embodiments, the LLM Gateway Toolkit allows the developer to select the LFM provider of choice, either from a catalog or by selecting “New LFM” (in which case he needs to provide the LFM Provider URL and the API Credentials to establish a successful connection), create a new LLM Group, which is a logical folder associated to the developer, and simply upload the new LLM models in the LLM group.

The LLM stack herein provides the developer with the flexibility of choosing both the LFM framework and a customer specific LLM model 250 for any given task based on the different LLM services needed to operate a conversational AI assistant. As a result, in some embodiments, developers can develop end to end LLM workflows or LLM services 260 which comprise more than one task by choosing a specific LFM/LLM model for each specific task to be executed in the pipeline.

In some embodiments, developers can calibrate each model per their objectives to deliver a high level of precision and accuracy. In some embodiments, LLM stack herein allows the developer to calibrate the mode using the below behaviors:

Zero-shot Learning: The developer can use the pre-trained LLM model as-is. Examples of such tasks are language detection, language translation, sentiment detection, emotion detection, etc.

Few-shots Learning (e.g., prompt engineering or inference-time tuning): In some embodiments, the developer guides the model to the desired output by providing the LLM model with few examples and instructions. In some embodiments, this calibration model does not alter the underlying parameters of the LLM models.

Instruction-based Fine-Tuning: This method may provide a higher level of precision and accuracy than zero-shot or few-shot learnings. In some embodiments, in this method, the developer trains the model using specialized datasets, which are high-quality human-generated prompt/response pairs specifically designed for instruction tuning LLMs. In some embodiments, this method of calibration acts deeper in the LLM model by updating the internal parameters used by the model. The model fine-tuning is the most advanced calibration method and may require both computing resources for training and supervised, high-quality and extensive datasets to generate the prompt/response sentence pairs for training.

In some embodiments, the Large Language Model (LLM) technology stack herein can operate in multiple industry verticals (e.g., logistics, healthcare, wealth management, retailers, banking, airlines, and insurance) and enterprise domains 270 (e.g., IT, HR, legal and compliance, finance, supply chain management, facilities). The Enterprise Domain LLMs are LLM models which have been extensively fine-tuned using prompt/response sentence pairs extracted from Enterprise Domain Packs (EDPs). In some embodiments, each Enterprise Domain Pack comprises a domain-specific ontology, which is an extensive set of entity classes, entity names, entity synonymous like entity expansions, and abbreviations (initialisms, acronymous, shortenings and contractions) and domain-specific taxonomy, which is an extensive set of intents (and intent phrases) associated to each entity of the ontology. Each domain EDP may comprise hundreds of thousands to millions of intent phrases.

In some embodiments, the Large Language Model (LLM) technology stacks herein use pre-packaged and fine-tuned a large pool of domain specific LLM Services 260 using one or more EDPs. The LLM Services 260 may be available to developers in a Service LLM catalog. In some embodiments, the developer uses the LLM Services 260 via an API or can select or drag/drop/chain them into a conversational workflow using a studio to build complete experiences around a service.

In some embodiments, the LLM stack herein provides a further level of LLM model customization beyond the calibration offered via the instruction-fine tuning and EDP. The Large Language Model (LLM) technology stack herein offers special learning pipelines, which act on the specific customer datasets (e.g., tickets, knowledge articles, call transcripts, etc.) which may automatically extract entities and intents which are very specific to the customer (e.g., within the domain of operation). In some embodiments, this custom-specific knowledge is then used to generate custom-specific prompt/responses which may then be used to execute a second round of instruction-based fine tuning on a proprietary Enterprise Domain LLMs, which may be fine-tuned using only the domain-specific EDPs. Exemplary proprietary AI Learning pipelines directly linked to instruction-based fine-tuning pf LLM models are listed below:

Tickets Learning Pipeline: Iteratively and continuously processes tickets and automatically extracts the main entities and associated intents. By grouping tickets tagged with the same pair of intents and entities, the pipeline may automatically generate intent phrases capturing the language diversity used by the specific customer to express the same concept.

Conversation Learning Pipeline: Iteratively and continuously processes user requests and calls transcripts, and automatically extracts the main entities and associated intents. By grouping conversations tagged with the same pair of intent and entity, the pipeline may automatically generate intent phrases capturing the language diversity used by the specific customer to express the same concept.

Knowledge Learning Pipeline: Processes ingested customer knowledge articles and may automatically extract the main entities, associated intents and large set of intent phrases from each article.

Ontology Generation: Consumes all the entity-based learning from the different pipelines, may automatically discover expansions, abbreviations, and relationships among the entities, and organizes all the entities into an ontology graph which may be made available as a catalog.

Taxonomy Generation: Consumes all the intent-based learning from the different pipelines and may automatically organize all semantic similar intents into a multi-category multi-level intent taxonomy which is made available as a catalog.

In some embodiments, the LLM stack herein provides an LLM evaluation level 240, which the user with a set of toolkits and APIs that developers can use to evaluate the performance of the LLM models herein. Developers can access toolkits and APIs for development, testing and benchmarking the following: prompt engineering (e.g., few shots learning), fine tuning, Model Selection via LLM catalog and LLM Gateway, model performance ranking which automatically scores the models against the same dataset to automatically stack rank LFM/LLM models based on the accuracy achieved, and manage customer datasets for instruction-fine tuning models.

In some embodiments, the LLM stack herein offers a comprehensive Orchestration and Deployment Layer 220 that is used to allocate and deploy resources (including servers, virtual machines, networking, security and storage), monitor software lifecycle operations, and recover from error conditions. In some embodiments, the LLM stack herein offers a large diversity of channels 210 to interface with users like Slack, Microsoft Teams, Cisco WebEx, Zoom, SMS/MMS, Email and Voice), Administrator Portal, Form Intercept and Agent Widgets.

In some embodiments, prompts can have a separate LLM Provider, internal or external (e.g., OpenAI, Bard, etc.). Input Variables can be passed into prompts (e.g., Chat history). In some embodiments, prompt groups and/or prompt chaining is implemented as well.

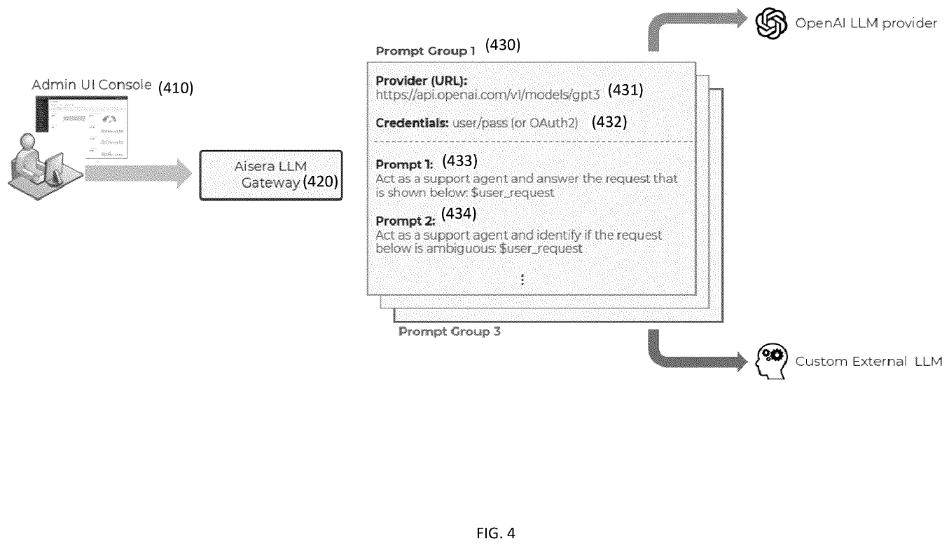

In some embodiments, per FIG. 4, an LLM provider is registered through a LLM Gateway by an Admin UI console 410. In some embodiments, prompts are added that will be used mainly for preconfigured Tasks through the LLM Gateway 420 (e.g., an Admin UI console). In some embodiments, calling the registered prompts can be performed by using a prompt for the main NLU path by inserting them inside the Pre-Handling Flow, or as an auxiliary capacity, by adding prompts inside a flow (e.g., using the new LLM action). In the example shown, a first prompt group 430 comprises a provider URL 431 and the associated credentials 432, a first prompt 433, and a second prompt 434. As shown, the first prompt 433 and the second prompt 434 of the first prompt group 430 are sent to an OpenAI LLM provider 450. Further, a second prompt group 440 is sent based on its provider URL (not shown), to a custom external LLM 460. In some embodiments, the LLM Gateway 420 determines, based on the prompt, the provider URL 431, the associated credentials 432, or any combination thereof whether to send the prompt to the OpenAI LLM provider 450 or to the custom external LLM 460. In some embodiments, the LLM Gateway 420 sends the prompt to the OpenAI LLM provider 450 for general prompts that can be answered by the OpenAI LLM provider 450. In some embodiments, the LLM Gateway 420 sends prompts specific to an organization, an application, or other specialized department to the custom external LLM 460.

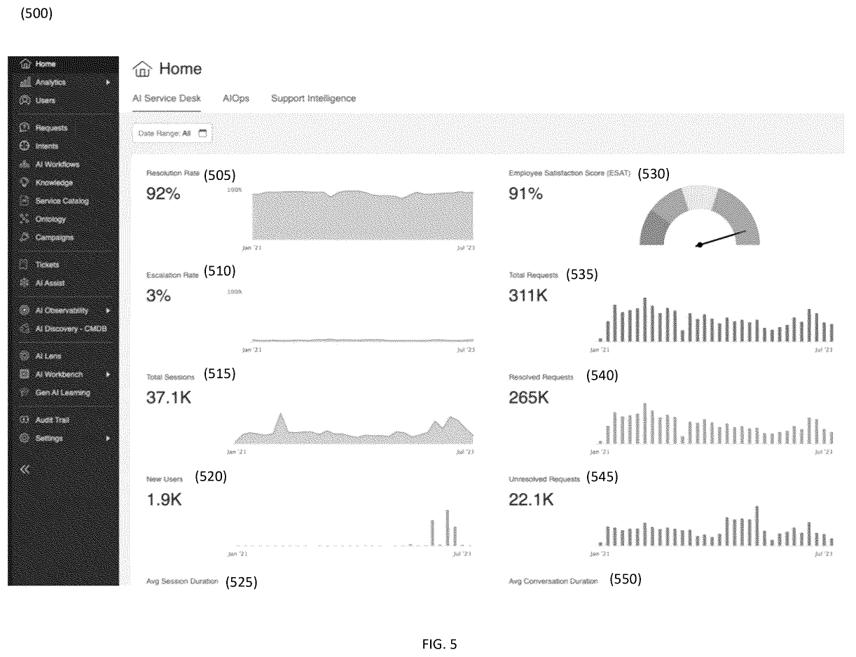

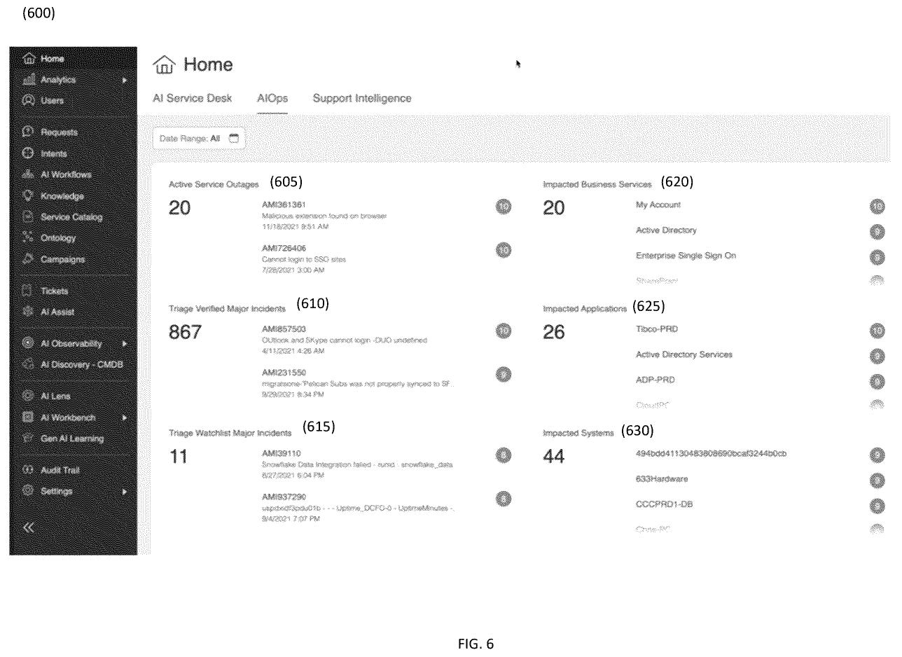

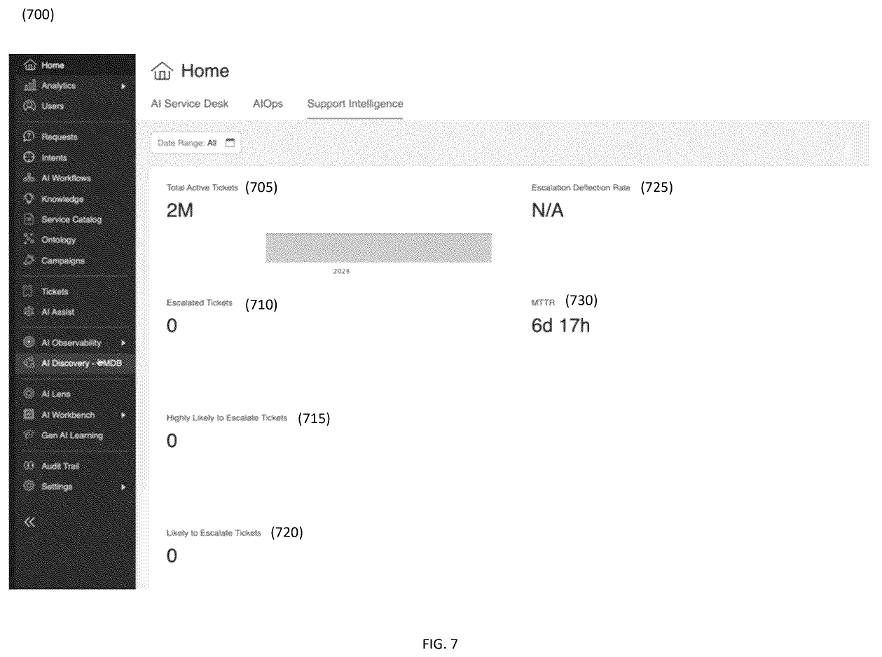

In some embodiments, technology stack described herein includes an administrative (or admin) console. In further embodiments, the admin console includes a front-end interface, such as a GUI. In still further embodiments, the GUI includes features allowing an admin user to review and configure features of the technology described herein. By way of example, in some embodiments, per FIG. 5, a GUI for an admin console 500 includes navigation elements allowing a user to access, by way of examples, analytics, users, requests, intents, AI workflows, knowledge bases, service catalogs, ontologies, campaigns, tickets, AI assist, AI observatory, AI discovery, AI lens, AI workbench, gen AI learning, an audit trail, and settings. Further, in some embodiments, per FIG. 5, a GUI for an admin console 500 includes an AI service deck feature providing access to data pertaining to, for example, resolution rates 505, escalation rates 510, total sessions 515, new users 520, average session duration 525, employee satisfaction score 530, total requests 535, resolved requests 540, unresolved requests 545, and average conversation duration 550. By way of further example, in some embodiments, per FIG. 6, a GUI for an admin console 600 includes an AI ops feature providing access to data pertaining to, for example, active service outages 605, triage verified major incidents 610, triage watchlist major incidents 615, impacted business services 620, impacted applications 625, and impacted systems 630. By way of still further example, in some embodiments, per FIG. 7, a GUI for an admin console 700 includes an support intelligence feature providing access to data pertaining to, for example, total active tickets 705, escalated tickets 710, highly likely to escalate tickets 715, likely to escalate tickets 720, escalation deflection rate 725, and mean time to recovery, repair, respond, or resolve (MTTR) 730.

### Overview

In some embodiments, the platforms, systems, media, and methods disclosed herein include knowledge article prediction from service tickets using at least one of an off-line pipeline or a real-time pipeline. In some embodiments, the off-line pipeline is used to train an intent to knowledge prediction model to predict one or more knowledge articles from a plurality of historical service tickets. In some embodiments, the real-time pipeline is used to provide knowledge articles with the intent to knowledge prediction model one or more knowledge articles from an open service ticket (e.g., describing an active question or issue faced by a user). In some embodiments, a ticket summarization and intent extraction model may be used to discern one or more enriched intents describing issues or questions had by a user from one or more service tickets (e.g., the historical service tickets or the open service ticket). In some embodiments, the primary purpose of the intent to knowledge article prediction model is to provide knowledge articles that are responsive to issues or questions described in the service tickets such that the knowledge articles may be used to provide a resolution to one or more issues or questions experienced by a user. In some embodiments, the knowledge articles and the primary intent may comprise an input into an LLM that may provide a resolution comprising portions of the knowledge articles so as to be responsive to the one or more enriched intents.

In some embodiments, the platforms, systems, media, and methods disclosed herein may be integrated with customer relationship management system or ticketing system to offer artificial intelligence-based recommendations based on knowledge articles and enriched intents from service tickets. The various embodiments disclosed herein provide at least improved, particular methods, systems, platforms, and media for the efficient resolution of open service tickets via the generation of grounded responses comprising portions of knowledge articles. Some benefits of integration of the platforms, systems, media, and methods disclosed herein include reduced mean-time-to-resolution, increased user productivity (e.g., service agent efficiency, customer engagement), improved service agent onboarding, and enterprise (e.g., business, organization, etc.) efficiency via auto-resolution of service tickets. Additionally, enterprise knowledge articles may contain inconsistent or repetitive information, the platforms, systems, media, and methods disclosed herein provide means for the custom generation of answers to specific user issues or questions that comprise solutions generated from the breadth of knowledge articles and not just those found by the user, which may or may not be accurate or sufficient to resolve the user's issues or questions.

Functional component modules include, by way of non-limiting examples:

Ticket Summarization and Intent Extraction Model. A service ticket is ingested by an LLM model to extract a summary and ultimately an intent (or intents) from the service ticket. The ticket summarization and intent extraction model may comprise a series of modules in cascade to perform the summarization and extraction processes. Ticket summarization may include the removal of erroneous detail to generate a summary of the service ticket such that the user intent (e.g., the issue or question to be resolved) and pertinent details (e.g., error codes) may be extracted from the summary to generate an actionable enriched intent that is reflective of the user issue or question. The enriched intent can then serve as input into a model trained to retrieve relevant knowledge articles to resolve the service ticket.

Intent to Knowledge Prediction Model. Enriched intent serves as input to an LLM (e.g., JoinBERT) trained to predict the most relevant knowledge articles for the enriched intent. The LLM model provides the knowledge articles from a database of knowledge articles (for example, an enterprise's historical solutions to employee or user issues) which may serve as a portion of input to later LLMs for generating a resolution to a user service ticket by incorporating snippets of the knowledge articles into an LLM generated answer. The intent to knowledge prediction model may be trained on a library of ground-truth data, where the ground-truth data comprises historical service tickets associated with historical knowledge articles (e.g., resolutions provided by service agents to close the historical service tickets).

Answer Generation Model. An LLM model which, given an enriched intent and the relevant knowledge articles predicted for the enriched intent, dynamically generates an answer which first acknowledges the user request, and then formulates a technical answer (e.g., question or issue resolution) by using portions of the relevant knowledge articles.

### Knowledge Prediction System

In some embodiments, the knowledge prediction system may be configured to contain both off-line and real-time pipelines. The off-line pipeline may provide enterprises (e.g., businesses, organizations) the means to use historical service ticket resolutions to fine-tune one or more LLMs for custom service ticket resolution. The off-line pipeline may, in some instances, enable enterprises to train or fine-tune highly accurate models to provide verifiable resolutions to active user issues or questions (embodied in open service tickets) regardless of the complexity of the user issue or underlying database of knowledge articles. Additionally, the real-time pipeline may provide enterprises the means to deploy the trained models to provide low-latency resolutions to open service tickets via chatbots or as part of a customer relationship management system. In some embodiments, the knowledge prediction system may provide knowledge articles to one or more service agents or users to aid in resolution of service tickets. In some embodiments, the knowledge articles may be provided to an LLM for the generation of an answer, where the user provided service ticket is provided an actionable resolution as detailed by the generated answer.

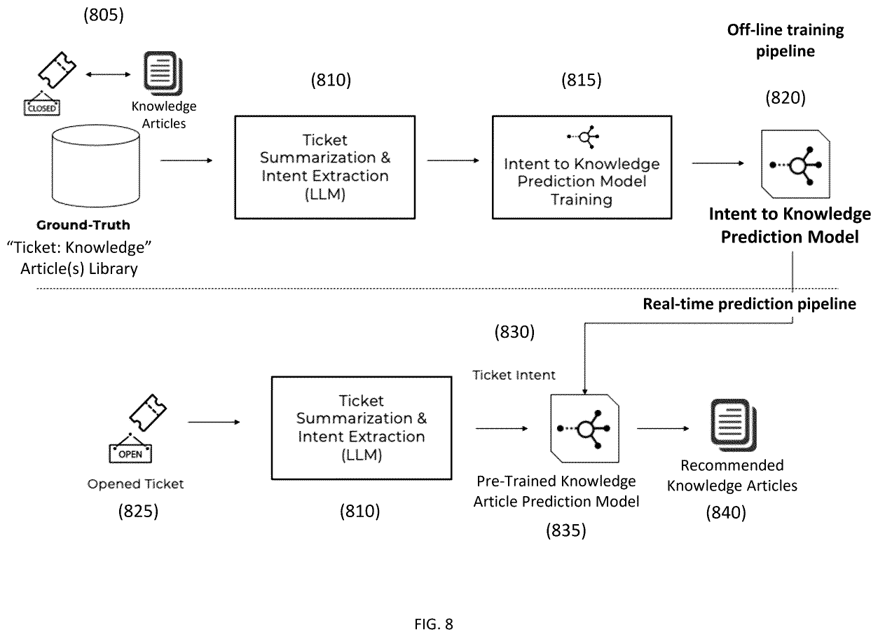

Shown in FIG. 8 are exemplary building blocks and information flow for off-line and real-time pipelines implementing an intent to knowledge prediction model that is capable of digesting user service tickets and outputting relevant knowledge articles to ultimately resolve the user service ticket. In the example of FIG. 8, a library (e.g., a mapping, dictionary, database) 805 of historical (e.g., previously submitted, resolved, and closed) service tickets to relevant knowledge articles (e.g., instructions on how to resolve an issue) may first be fed to a ticket summarization and intent extraction model 810 before being used in intent to knowledge prediction model training 815. The library 805 may be considered a ground-truth association between service tickets (and their implied intents) and knowledge articles. In some embodiments the ticket summarization and intent extraction model 810 may comprise two modules (e.g., LLMs) in cascade that first summarize a service ticket and subsequently extract one or more enriched intents from the service ticket. The enriched intents extracted from the service tickets comprise at least the issue or question faced by the user (e.g., microphone not working, how to enroll in 401k plan) and key details necessary to resolution of the issue (e.g., error codes, user role). In the off-line pipeline, the enriched intents are extracted from the service tickets (e.g., historical service tickets) of library 805 and are used as training inputs for the intent to knowledge prediction model training 815, using the knowledge articles associated with the historical service tickets from which the enriched intents were extracted as training labels. The trained intent to knowledge prediction model 820 from the intent to knowledge prediction model training 815 process may be used to predict relevant knowledge articles to resolve the user issue or question from enriched intents, ultimately configuring the intent to knowledge prediction model 820 to be suitable for a real-time prediction pipeline. In the real-time prediction pipeline, a user may submit a ticket, herein an opened ticket 825, which may be fed through the ticket summarization and intent extraction model 810 in the same manner as the historical service tickets of the library 805, providing one or more ticket intent 830 to be input into a pre-trained knowledge article prediction model 835 (e.g., the intent to knowledge prediction model 820 of the off-line pipeline). The pre-trained knowledge article prediction model 835 may predict one or more recommended knowledge articles 840 (e.g., from the library 805 or an enterprise documentation database) to resolve or close the user issue or question as described in the one or more ticket intent 830.

In some embodiments, the library 805 may comprise historical service tickets. The historical service tickets may be associated with one or more historical knowledge articles. The historical service tickets may be a collection of prior service tickets opened by users of a various enterprise, for example users that have experienced technical issues or questions using an enterprise's software in the course of their daily work life. The enterprise-specific historical service tickets may provide informative training data for custom models to be used in enterprise service ticket resolution. Fine-tuned LLMs may leverage transfer learning from prior trained LLMs to provide custom solutions to service ticket resolution.

The ticket summarization and intent extraction model 810 may comprise one or more LLMs that are configured to perform at least ticket summarization and intent extraction. Ticket summarization and intent extraction enables the generation of information dense, or enriched, user queries that may be used to later provide informative embeddings that may be mapped to relevant knowledge articles in a latent space or embedding space. In some embodiments, the summarization aspect may be used to reduce erroneous or spurious information from the user query or service ticket (e.g., salutations, external links, irrelevant details). The process of ticket summarization and intent extraction may convert an indirect, conversational style user communication into a dense, actionable representation of user issues or questions that provides pertinent details such as error messages, status codes, warning messages, system warnings, or references to products. The ticket summarization and intent extraction model 810 is configured to ignore spurious or irrelevant details input by a user when describing their issues to reduce the input into an intent enriched by the pertinent details described above.

In some embodiments, the ticket summarization and intent extraction model 810 may be configured via a prompt to provide the summarization and extraction functions. For example, the ticket summarization and intent extraction model 810 may be engineered via a prompt to digest service tickets and produce direct, actionable intents that are enriched into direct, actionable requests by the user for support in resolving their issues or questions. Further, the ticket summarization and intent extraction model 810 may be engineered to reply in a consistent format (e.g., structured JSON) that may be later used for vector embedding by an LLM or other machine learning model.

The intent to knowledge prediction model training 815 process may comprise training one or more LLMs (e.g., the intent to knowledge prediction model 820 or the pre-trained knowledge article prediction model 835) to associate ticket intents (e.g., derived from the ticket summarization and intent extraction model 810) with knowledge articles. The training process may comprise generating vector embeddings of intents and knowledge articles and training the one or more LLMs to predict one or more knowledge articles based on a similarity measure (e.g., cosine similarity). The similarity measure may provide a means of determining the relative similarity of (or distance or angle in latent space between) an intent and a knowledge article so as to provide the most relevant knowledge articles for an intent as measured by their embedding/vector representation similarities in the latent space learned during the intent to knowledge prediction model training 815.

The intent to knowledge prediction model training 815 results in the trained intent to knowledge prediction model 820. The trained model is configured to provide the most relevant knowledge articles for a given intent, whether or not the knowledge articles were associated with an intent in the library 805. The intent to knowledge prediction model 820 is trained to generalize the process of predicting knowledge articles from intents, providing the most relevant knowledge articles to ultimately resolve the issue or question faced by the user as implied by the intent from which the knowledge articles are predicted.

In some embodiments, the recommended articles may be provided to the user to enable the user to resolve user issues or questions. In some embodiments, the knowledge articles are further fed to an answer generation system to obtain tailored resolutions to user issues or questions such that the resolutions are based on the knowledge articles and the user issue or question as implied by one or more intents extracted from the service ticket describing the user issue or question.

### Answer Generation System

In some embodiments herein, an answer generation system may be used in combination with the knowledge prediction system to provide resolutions to open service tickets. The answer generation system may be configured to provide answers to users that are grounded in the documentation of an enterprise so as to provide logical resolutions to user issues or questions. The answer generation system may leverage one or more LLMs to provide conversational style support to users, enabling users to have their issues or questions resolved while also providing means for interaction with the system to provide additional information, feedback, or clarification. In some embodiments, the answer generation system may provide knowledge articles to one or more service agents or users to aid in resolution of service tickets.

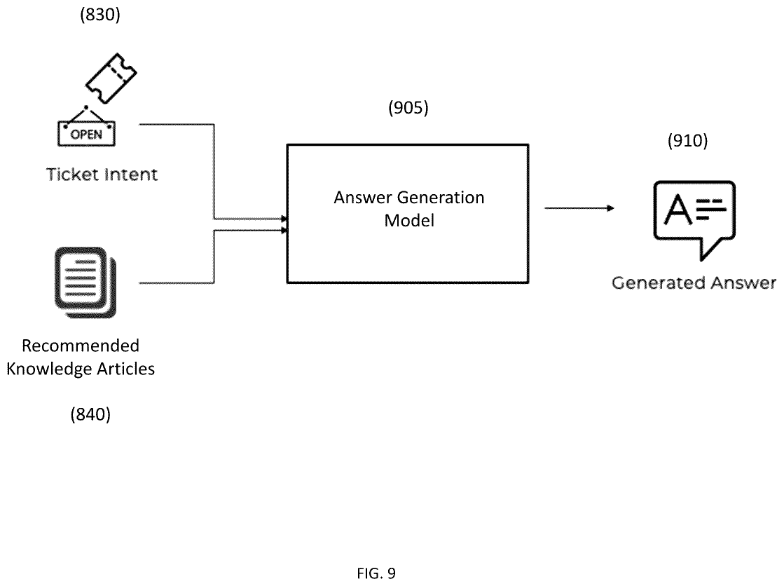

Shown in FIG. 9 are exemplary building blocks and information flow for generating an answer responsive to a user issue using the one or more ticket intent 830 and the one or more recommended knowledge articles 840. The answer generation model 905 comprises one or more LLMs to provide a generated answer 910 that is both responsive to the one or more ticket intent 830 while including portions of the recommended knowledge articles 840 so as to provide an actionable answer to the user. In some cases, the answer generation model 905 may be configured to receive the outputs of the knowledge prediction system directly.

The answer generation model 905 may be configured to receive a set of instructions for how to process service tickets and intents. For example, the answer generation model 905 may receive instructions for how to format the generated answer 910 and for how to arrive at the generated answer 910. The answer generation model 905 may be configured via the instructions to organize the relevant portions of the knowledge articles into an answer that is actionable and grounded (e.g., via links to the full knowledge articles). The generated answer 910 may be further configured for interaction with the user, where the user can request further information, clarification, or provide feedback to the answer generation model 905 regarding the quality of the generated answer 910.

The answer generation model 905 may comprise one or more LLMs configured to ingest one or more knowledge articles, extract snippets from the knowledge articles that are responsive to the one or more ticket intent 830 and generate an informative and interpretable resolution for the user. In some embodiments, the answer generation model 905 may generate query embeddings from the one or more ticket intent 830 and provide knowledge article snippets (e.g., the recommended knowledge articles 840) that have a semantically similar embedding as the one or more ticket intent 830. In some embodiments, the generated answer 910 may include a series of instructions to the user to aid the user in resolving their issue, and in some cases the generated answer may include knowledge article hyperlinks for the user to gather more information. In some embodiments, the answer generation model 905 may comprise a third party LLM (e.g., ChatGPT) or an enterprise software solution that is configured to provide resolutions to user issues or questions.

### EXAMPLES

The following illustrative examples are representative of embodiments of the software applications, systems, and methods described herein and are not meant to be limiting in any way.

### Example 1—Prompt Engineering of Ticket Summarization and Intent Extraction Model

The following is an exemplary prompt input into an LLM to achieve enriched intent extraction:

```
  Act like a customer support agent for $companyName, asked to resolve
support tickets related to topics found at $companyDomain. When given a
support ticket ($inputTicket), follow the instructions below to process
the ticket and return your response in a JSON-formatted response
($responseJSON) which is defined as:
  {
  “intent”: string,
  “system_messages”: strings,
  “enriched_intent”: string,
  }
  I want you to process the $inputTicket by following step-by-step the
instructions below.
  Instruction 1. Extract the main user intent from $inputTicket.
Transform the intent into a direct and actionable intent using no more
than 12 words. Save the intent in “intent”.
  Instruction 2. Extract any error codes, system messages, status
codes from $inputTicket. Save them (if available) “system_messages”,
separated by comma.
  Instruction 3. If “system_messages” is not empty, enhance the user
intent by concatenating “intent” with “system_messages”. Transform the
enhanced intent into a direct and actionable request and save it to
“enhanced_intent”. If “system_messages” is empty, copy “intent” into
“enhanced_intent”.
  Return ONLY $responseJSON. No more information shall be returned.
  The $companyName is “XXX”. The $companyDomain is “YYY”. The
$inputTicket is: “”.
```

### Example 2—Input and Output from Ticket Summarization and Intent Extraction Model

The following is an example service ticket input and LLM output for the ticket summarization and intent extraction model:

Input into LLM

```
  Ticket ID:2321457, Ticket Title: I'm not able to add users to Auth0,
it produces an error. Ticket Description: When i attempt to add a new
user i get a 500 error in the console and I'm not able to complete the
user registration. Any help you can provide would be awesome.
Output of LLM
  ticket ID 2321457 >> {″intent″: ″Add users to Auth0″,
″system_messages″: “500 error in console”, ″enriched_intent″:
″Add users to Auth0 and resolve 500 error in console″}
```

### Example 3—Input and Output from Ticket Summarization and Intent Extraction Model

The following is an example service ticket input and LLM output for the ticket summarization and intent extraction model:

Input into LLM

```
  Ticket ID : 2318074, Ticket Title: Customer unable to access Unit21
via Auth0, Ticket Description: Hi there,
  We are having another issue with one of our customers trying to
connect through eu-sandbox1-unit21. When I go to user's history here:
https://manage.auth0.com/dashboard/eu/eu-sandbox1-
unit21/users/c2FtbHAlN0N1MjEtdHJvbGxleS1nb29nbGUtd29ya3NwYWNlJTdDam9uLnNr
ZWV0JTQwdHJvbGxleS5jb20 everything seems to be working. But there are two
failures at the same time this user was attempting their last login that
I believe are related to the issue here:
https://manage.auth0.com/dashboard/eu/eu-sandbox1-
unit21/logs/90020230817230233084861000000000000001223372051935679307?page
=1 and here: https://manage.auth0.com/dashboard/eu/eu-sandbox1-
unit21/logs/90020230817230306279741000000000000001223372051935707381?page
=1 It looks like jon.skeet@trolley.com keeps getting this failed silent
auth - login required error and I can't figure out how to resolve it.
Their Google Workspace email matches their agent email. I've had them
disable any extensions and try multiple browsers. Their SAML connection
is titled: u21-trolley-google-workspace and I created my own test
enterprise SAML connection that is configured the same way here: u21-
test-google-workspace and I am not having any issues connecting.
  Can you point me in the right direction here maybe and give me some
idea of what is happening? As far as I can tell the connection should be
working.
Output of LLM
  ticket ID 2318074 >> {″intent″: ″Customer unable to access Unit21
via Auth0″, ″system_messages″: “Failed silent auth - login required
error″, “enriched_intent″: ″Customer unable to access Unit21 via Auth0
due to failed silent auth - login required error″}
```

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure.

What is claimed is:

1. A computer-implemented method for knowledge article prediction from historical service tickets comprising:
a) providing an off-line training pipeline configured to perform operations including:
i) receiving a plurality of historical service tickets,
ii) applying a ticket summarization and intent extraction model to extract one or more historical service ticket enriched intents from each of the plurality of historical service tickets, and
iii) training an intent to knowledge prediction model to predict one or more historical knowledge articles from each of the one or more historical service ticket enriched intents; and
b) providing a real-time prediction pipeline configured to perform operations including:
i) receiving an open service ticket,
ii) applying the ticket summarization and intent extraction model to extract one or more open service ticket enriched intents from the open service ticket,
iii) applying the intent to knowledge prediction model to predict one or more knowledge articles from each of the one or more open service ticket enriched intents, and
iv) providing the one or more knowledge articles.

2. The method of claim 1, further comprising applying an answer generation model to generate an answer resolving the open service ticket from the one or more knowledge articles and the one or more open service ticket enriched intents.

3. The method of claim 2, wherein the answer generation model comprises one or more large language models (LLMs).

4. The method of claim 3, wherein the one or more LLMs are trained on a library of historical service tickets.

5. The method of claim 4, wherein the library includes at least 100, at least 1,000, or at least 10,000 historical service tickets.

6. The method of claim 4, wherein one or more of the historical service tickets are associated with at least one of the one or more historical knowledge articles.

7. The method of claim 2, wherein the answer comprises at least a portion of at least one of the one or more knowledge articles.

8. The method of claim 2, wherein the answer comprises the one or more knowledge articles.

9. The method of claim 2, further comprising providing the answer to one or more of a service agent, a LLM, or a user device.

10. The method of claim 1, wherein the ticket summarization and intent extraction model comprises one or more LLMs.

11. The method of claim 1, wherein the ticket summarization and intent extraction model comprises a summarization module and an extraction module.

12. The method of claim 11, wherein the summarization module generates a service ticket summary and the extraction module extracts one or more enriched intents from the service ticket summary.

13. The method of claim 1, wherein the ticket summarization and intent extraction model is configured to receive instructions for how to process a service ticket.

14. The method of claim 13, wherein the instructions comprise operations including entity extraction, entity enrichment, or output formatting.

15. The method of claim 1, wherein the ticket summarization and intent extraction model is configured to perform operations including:
a) extracting one or more intents from a service ticket,
b) extracting one or more system messages from the service ticket,
c) enriching the one or more intents with the one or more system messages, and
d) providing the one or more enriched intents.

16. The method of claim 1, wherein one or both of the one or more historical service ticket enriched intents or the one or more open service ticket enriched intents are at least a portion of a JSON-formatted output of the ticket summarization and intent extraction model.

17. The method of claim 1, wherein the intent to knowledge prediction model comprises an LLM.

18. The method of claim 17, wherein the LLM is trained on a library of historical service tickets associated with historical knowledge articles.

19. The method of claim 18, wherein the library includes at least 100, at least 1,000, or at least 10,000 historical service tickets associated with historical knowledge articles.

20. The method of claim 1, wherein each of the one or more historical service ticket enriched intents comprises an intent and a plurality of system messages.

21. The method of claim 1, wherein each of the one or more open service ticket enriched intents comprises an intent and a plurality of system messages.

22. The method of claim 21, wherein the plurality of system messages comprises one or more of error messages, status codes, warning messages, system warnings, or references to products.

23. The method of claim 1, wherein each of the plurality of historical service tickets comprises a ticket ID, a ticket description, or a ticket title.

24. The method of claim 1, wherein the open service ticket comprises a ticket ID, a ticket description, or a ticket title.

25. The method of claim 1, wherein one or more of the plurality of historical service tickets or the open service ticket are received from a user device.

26. A computer-implemented method for knowledge article prediction from an open service ticket comprising:
a) receiving the open service ticket;
b) applying a ticket summarization and intent extraction model to extract one or more open service ticket enriched intents from the open service ticket;
c) applying an intent to knowledge prediction model to predict one or more knowledge articles from each of the one or more open service ticket enriched intents; and
d) providing the one or more knowledge articles.

27. A computer-implemented system comprising at least one processor and instructions causing the at least one processor to perform operations comprising:
a) providing an off-line training pipeline configured to perform operations including:
i) receiving a plurality of historical service tickets,
ii) applying a ticket summarization and intent extraction model to extract one or more historical service ticket enriched intents from each of the plurality of historical service tickets, and
iii) training an intent to knowledge prediction model to predict one or more historical knowledge articles from each of the one or more historical service ticket enriched intents; and
b) providing a real-time prediction pipeline configured to perform operations including:
i) receiving an open service ticket,
ii) applying the ticket summarization and intent extraction model to extract one or more open service ticket enriched intents from the open service ticket,
iii) applying the intent to knowledge prediction model to predict one or more knowledge articles from each of the one or more open service ticket enriched intents, and
iv) providing the one or more knowledge articles.

28. One or more non-transitory computer-readable storage media encoded with instructions executable by one or more processors to provide an application comprising:
a) a software module providing an off-line training pipeline configured to perform operations including:
i) receiving a plurality of historical service tickets,
ii) applying a ticket summarization and intent extraction model to extract one or more historical service ticket enriched intents from each of the plurality of historical service tickets, and
iii) training an intent to knowledge prediction model to predict one or more historical knowledge articles from each of the one or more historical service ticket enriched intents; and
b) a software module providing a real-time prediction pipeline configured to perform operations including:
i) receiving an open service ticket,
ii) applying the ticket summarization and intent extraction model to extract one or more open service ticket enriched intents from the open service ticket,
iii) applying the intent to knowledge prediction model to predict one or more knowledge articles from each of the one or more open service ticket enriched intents, and
iv) providing the one or more knowledge articles.
